(19) United States
(12) Patent Application Publication
(10) Pub. No.: US 2009/0211129 A1
(43) Pub. Date: Aug. 27, 2009

(54) Information device comprising a housing

(76) Inventor: Kalman Böjthe, Eltmann (DE)

Correspondence Address: Scott R. Foster;Pandiscio & Pandiscio, 470 Totten Pond Road, Waltham, MA, 02451-1914, US

(21) Appl. No.: 11/658,707

(22) PCT Filed: Aug. 25, 2004
(86) PCT No.: PCT/EP04/09485

§ 371 Date: Nov. 10, 2008

(30) Foreign Application Priority Data
Aug. 3, 2004 (DE) 20-2004-012-200.6

(51) Int. Cl. G09F 11/21

(52) U.S. Cl. 40/518

(57) ABSTRACT

The invention is directed to an information apparatus attached or attachable to a vehicle and comprising an elongated, flexible, information-bearing sheet, canvas, sailcloth or the like, which by each of its two narrow sides can be looped around a respective one of two spaced-apart, roughly mutually parallel, rotatably mounted winding drums and can be wound therearound in plural layers, which² are arranged such that regions of the information sheet are visible between the winding drums, and which to effect their rotational adjustment are each coupled to a respective drive motor, such that different regions of the information sheet become visible; according to the invention, the information-bearing sheet, canvas, sailcloth or the like and the respective winding drums are disposed collectively in a closed housing of flat shape, comprising on its outward side a viewing window and in the region of its back side and/or one or more of its end faces means for affixing the housing to a rearward and/or lateral outer surface of the cargo space or of a cargo area covering. ²“Which” refers to the winding drums; see Footnote 1, first page of the specification.

The invention is directed to an information apparatus attached or attachable to a vehicle, particularly a truck, and comprising an elongated, flexible, information-bearing sheet, roller-blind fabric, canvas, sailcloth or the like, which by each of its narrow ends is looped around a respective one of two spaced-apart, roughly mutually parallel, rotatably mounted winding drums and can be wound therearound in plural layers, which¹ are arranged such that one rectangular region of the information sheet at a time is visible, one side length of which region is approximately equal to the length of the winding drums and the other side length whereof is approximately equal to the distance between the winding drums, each of the two winding drums being coupled to a respective drive motor to effect its rotational adjustment in such fashion that different regions of the information sheet become visible. ¹The German syntax is ambiguous here, but Claim 1 makes it clear that “winding drums” is the antecedent.

There has been a steady shift in goods transport from rail to road over the years, and this as yet unbroken trend has had the effect of placing a huge number of trucks on our highways. From the very start, these trucks have been used as advertising and information media, for example by imprinting their superstructures, tarpaulins, etc., with a wide variety of messages. This approach is no longer suited to the times, however. For one thing, the coalescence of the European Union has brought about an increase in transborder traffic, and due to multilinguality within Europe, advertising or informational messages on the tarpaulin of a Polish truck, for example, have proven quite useless in Germany, since only a small fraction of the German population knows Polish.

A way must therefore be devised, using the simplest possible means, to adapt the advertising or other informational messages appearing on trucks used for international goods transport to the language of the country concerned. For large carriers, it would additionally be desirable to be able to make a least a portion of the potential advertising surface area on the carrier's truck available to the client, thus simultaneously permitting individual advertising for the goods that are being shipped.

Known from the applicant's prior application, published under the publication number EP 1 288 890 A1, is an information apparatus of this kind in which a sheet is affixed by each of its two narrow sides to a respective winding drum and can be wound back and forth between them to make different advertising surfaces visible in the intervening region. This technique signifies a far-reaching advance, since in principle it opens up the possibility of making different advertising messages visible with few manipulations. To protect against the weather, each of the two winding drums is surrounded by a respective separate housing. Since the sheet region between them is exposed not only to the weather but also to the headwind, it is further proposed to cover the sheet with a transparent sheet or with Plexiglas at that location. A Plexiglas covering, unlike a transparent protective sheet, does provide effective protection against the effects of the headwind. However, it has been found that a cover panel is not sufficient to keep the mechanism in operating order under extreme weather conditions (heat, dust, rain, mud, slush, frost, snow, ice, etc.); even leadthrough slits for the information sheet in the winding drum housings are enough to allow the ingress of dust and particularly moisture, rapidly diminishing the service life that may be expected of the electronics and especially the drive motors. This is especially true of information systems mounted in the region of the back of a truck, since vast quantities of rainwater and slush are churned up there during travel on rain-wet roads, and everything becomes soaked or mud-clogged in no time.

From the foregoing comes the problem initiating the invention, which is to provide an information apparatus by means of which the information presented can be changed by one person with few manipulations and which nevertheless permits a long service life, particularly on the order of many years.

The solution to this problem is achieved, in an information sheet of the aforesaid kind, by the fact that the information-bearing sheet, roller-blind fabric, canvas, sailcloth or the like and the respective winding drums are arranged together in a closed housing of flat configuration, which is provided on its flat outward side with a window, and in the region of its back side and/or one or more of its end faces comprises means for securing the housing to a rearward and/or lateral outer surface of the cargo space or of a cargo area covering.

It is not necessary in this case to pay out the entire sheet in order to change the advertising information, but only to make a rotational adjustment of the winding drums, in which process the old and no longer timely advertising message is wound up onto a drum along with the relevant section of the sheet, while an additional region of the sheet, bearing the now-desired information, is simultaneously unwound from the opposite drum. Thus, only a rotational adjustment of the winding drums is necessary in order to change the information, and this can be effected automatically by means of an electric motor. Such an adjustment can thus be made even when the vehicle is in motion. Due to the torque-proof coupling of the information sheet to the winding drums, the information sheet continues to be rolled up by the driving of one of these drums. This torque-proof coupling to the jacket of the winding drum can be implemented in an extremely wide variety of ways, which are detailed subsequently hereinbelow. It is, however, crucial that there be no further possibility of relative rotation between the jacket of the winding drum and the information sheet. At the same time, it must be ensured that the length of the information sheet in its extent perpendicular to the winding axes is equal to at least twice the distance between the two winding drums, so that a corresponding rotational adjustment thereof completely winds up the segment of sheet bearing the no longer timely imprint and can be replaced by a region unwound from the respective other winding drum. Based on the inventive principle, the various information fields on the sheet are imprinted completely independently of one another or are provided in some other way with the relevant information. In particular, colorants that are reflective when illuminated can also be used for this purpose, so that at night, information that is lit up for example by the headlights of following vehicles shows up in a clearly visible manner. Portions of the information can also, of course, be implemented by means of stickers. Because of the closed housing, the winding mechanism functions reliably even under the worst weather conditions. At the same time, the viewing window can be cleaned at any time, using a water jet, scrub brush or the like, to make the respective advertising message show up in a clearly visible manner. The closed housing simultaneously keeps the headwind from inflating the information sheet like a sail, or even tearing it to shreds or ripping it off the winding drum.

The rearward outer surface of the cargo space is to be preferred over a lateral region of the sidewall or the cargo area covering, since an advertising message placed there can be made out very well by following traffic. The inventive information apparatus is preferably a retrofittable element, which in that case can be installed almost anywhere, for example on semi trailers, on the backs of buses, but also on streetcars or other vehicles designed to carry freight or people. Because of the closed housing, the inventive information apparatus is ideally suited for these areas of a vehicle, with their particularly heavy exposure to environmental influences.

It has proven favorable for the housing to be made of a material that has a density of less than 5 kg/dm³, preferably of less than 4 kg/dm³, particularly of less than 3 kg/dm³. Since according to the invention not only the two winding drums, but also the entire space taken up by the information sheet, including between the winding drums, is surrounded, the housing is much larger and thus heavier than heretofore; if it were made of commonly employed materials such as iron or steel, then it would be too heavy for the superstructure of a truck and so might cause damage to it, for example in the event of a sudden deceleration. The invention instead recommends using a light material such as aluminum for the housing. In this way, the weight of the information apparatus inclusive of housing can be reduced by about one-third, and thus to values that are not detrimental to the integrity of the superstructure.

The invention further recommends sealing the housing to forestall the ingress of moisture, dust, and even any flammable gases that may be present. Such an encapsulation, protected against dust, moisture or even explosions, enables the apparatus to be used with any type of truck, completely regardless of its cargo.

It is within the scope of the invention that the information apparatus is implemented as a door to the cargo space of the truck. This is done in the knowledge that the loading opening of almost every truck is located at the rear, which is the preferred location for the inventive information apparatus. If the information apparatus is integrated with the door, the overall weight of the door, the information apparatus and the housing can be minimized.

Further advantages are gained if the door extends over the entire back wall of the truck's cargo space. In the ideal case, the overall height or width of the truck superstructure can be used as an advertising surface. The invention recommends arranging the housing such that, insofar as possible, it does not increase the vehicle's overall cross section, to avoid having an adverse effect on overhead and side clearance and aerodynamic drag. By the same token, the expenditure for mechanics and control is minimized, since a total of only one winding drum at the top and only one winding drum at the bottom is necessary in such cases. There is no need to subdivide the information sheet, which would entail not only increased production expenditure, but also high requirements in terms of the (relative) positioning accuracy of the two halves of the sheet.

This inventive idea can be improved by suspending the door such that when open, it can be swung outward onto an adjoining wall region of the cargo space covering. In this way, the door, which juts out because of its width, can be swung completely to one side and the loading process is not impeded in any way.

Due to the thickness of the housing, which is greater than the diameter of a winding drum, such a swing angle of up to 270° raises design problems. These are solved by the fact that the door hinges, and thus the pivot axis of the door, are relocated to the region of the outward edge of an end face of the door rather than being disposed on an edge confronting the cargo space. To this end, the door hinges are preferably disposed at the respective back ends of elongated and backwardly oriented, cantilever-type elements, which are fastened by their respective front ends to the cargo space sidewall, preferably on the outward side and in a region that is reinforced in the manner of a portal.

According to an advantageous improvement, counterparts of the door closing mechanism are disposed, on the one hand, on the portal of the cargo space opening, and on the other hand, in that region of the cargo space sidewall to which the door lock swings when the door is opened completely. The door can thus be fixed both in the fully closed position and in the fully opened position, thereby completely preventing any unintended movement thereof, for example under the effect of gravity.

To permit access to the information sheet, a portion of the housing can be swung out, preferably a region that is accessible from the outside, particularly the viewing window. Opening the viewing window makes it is possible for example to release the snap-type fasteners at the respective sheet end, which are accessible once the information sheet has been unwound completely from a winding drum, from their counterparts on a winding drum, so that the sheet can be wound up completely onto the other winding drum. Provided that at least one of the winding drums is removably received in the housing, the fully wound drum can then be removed from its holder and replaced by another one. It is advantageous for this purpose if the swing-out viewing window is larger than a winding drum. Once a new drum has been put in place, its information sheet can be paid out to the other drum and fastened thereto with the viewing window still open, and only after that is the viewing window closed.

If the frame of the window is located concentrically inside a region of the housing forming a casing, then it is possible to open the window completely regardless of the position of the cargo space door. The cargo space need not be opened in order to replace the information sheet. This is especially important in the case of vehicles that have been sealed by customs officials.

The information sheet preferably has an elongated shape whose aspect ratio is greater than 2:1, preferably greater than 5:1, particularly greater than 10:1. Since an area used for advertising messages is usually expected to have a roughly square shape, given the recommended dimensions, at least two, preferably five, particularly ten or more mutually independent information fields can be stored and presented to the public as needed.

Additional advantages result in this case if the information sheet is provided on its narrow sides with means for fastening it to the winding drums, particularly snap-type fasteners, hook elements, adhesive strips or the like, whose counterparts are disposed on the outer jacket surfaces of the winding drums. By contrast, an alternative embodiment hereto, in which the information sheet is configured as endless and is or comes to be merely stretched tight around the winding drums, requires a torque transmission system that operates by friction fitting alone, which may entail not only a shorter information sheet, but also problems in exactly positioning an information field.

The fastening means are to be configured such that at any time the information sheet can be detached nondestructively from the respective winding drum and also remounted on it, on the one hand to provide temporary access to the cargo area, and on the other hand so that the sheet can be replaced with another copy or changed, for example so as to modify the displayed information or insert an additional information field or the like. The fastening means on the information sheet are mated with counterparts disposed on the inward jacket surfaces of the winding drums. These fastening means are fixed such that they cannot be displaced relative to the respective winding drum, and therefore permit slip-free transmission of the torque from the winding drums to the information sheet. Such fastening means, for example snap-type fasteners, can be disposed sunk in a groove- or furrow-shaped recess provided in the drum jacket and parallel to the shaft, so that these elements have no adverse effect on the winding properties of the respective drum concerned.

The invention permits an arrangement such that one of the two winding drums is located in the region of the top edge of the housing and one in the region of its bottom edge. In this case the information sheet need not be pulled very taut to keep it from sagging, which has a positive effect on the durability of the sheet.

The winding drums can be provided at their ends with guide disks. These guide disks are intended to ensure a flawless winding process, including specifically in the eventuality that the information sheet has for example come away from the U-shaped bars provided for it.

The winding drums are preferably mounted on mountings fixed in the common housing. The winding drums are preferably mounted in the region of endwise shaft stubs or prolongations, ball bearings having proven themselves by virtue of their long life.

To wind up the information sheet, each winding drum is provided with a respective drive mechanism. Such a drive mechanism need only be able to drive its winding drum in the direction of rotation that causes the information sheet to be wound up thereon. Unwinding is always effected by transmission of the tension from the respective other winding drum via the information sheet.

In realization of this inventive idea, the shaft of each winding drum is coupled to a respective drive motor, particularly an electric motor. This makes it possible to adjust the information sheet even when the vehicle is in motion, as long as a mechanism is provided to stop the respective drive motor in a closely defined position of the information sheet. Any common type of electric motor can be used, but particularly direct-current or step motors with a low voltage rating, since the power applied by such motors can be comparatively low. A reducing gear can also be used where the occasion demands, since the winding speed need not be very great. The power of the drive motor can be between approximately 100 and 500 W, depending on the specific application.

The invention recommends giving the drive motor an elongated, slender shape and disposing it inside the winding drum. Such drives, known inter alia as tubular motors, are designed to be able to fit into a cavity in the winding drum. Where applicable, the rotor, which is external in this type of motor, can also be used directly as the winding drum if suitable fastening means for the information sheet are present. This type of motor has the advantage that no additional, space-robbing installations are needed at the ends of the winding drums, so the overall volume of the housing can be minimized.

The energy for operating the electric motors can be extracted from the on-board electrical system. A direct-current motor with a rated voltage of 12 or 24 V can draw its drive energy directly from the intrinsic on-board electrical system. For motors with a higher rated voltage, voltage conversion can be performed, for which there are various known principles, for example a clocked transducer or the like.

To bring about a defined and coordinated rotational movement of both winding drums, the electric motors are provided to be coupled to a control device. The purpose of such a control device is to ensure that the information sheet is held stretched taut between the winding drums, but cannot tear. Said control device can be configured or programmed such that one drive motor at a time is operated as a braking device, thus eliminating the need for additional brakes.

The activation of the driving electric motor must be coordinated with the braking electric motor associated with the respective other winding drum in such a way that free rotational movement is possible and the information sheet cannot tear. To this end, it must be ensured that the latter motor is shifted into an easy-running state, i.e., it must also be driven (at reduced power) to assist the winding movement, specifically in the same winding direction as the driving motor, but at a (slightly) lower nominal rotation speed therethan. Since the actual rotation speeds must be the same, however, a continual adjustment offset will be created in one or both of the motors, and the single, overriding control device will continually try to compensate for this offset, thus yielding the (adjusted) tension in the information sheet.

A control device coupled to both drive motors for the synchronous adjustment thereof is also provided to be integrated into the housing, to limit the therewith-associated wiring expenditure in the interior of the housing. The coupling to the drive motors of both winding drums can therefore be realized in a simple manner by means of leads run inside the housing. The motors can be activated by means of relays or electronic switches or by means of direct-current converters, to be able to start and stop the motors smoothly.

As an alternative to the above-cited rotation speed control involving different nominal values, it is also possible to make use of the measurement signals from position transducers and/or torque transducers or motor current sensors in the supply lines of the drive motors to calculate and/or limit the tension present in the information sheet on the basis of the two torques, computed, as the case may be, from the rotation speed, the current and/or power consumption and the acceleration.

To this end, the control device can calculate the tension of the information sheet by taking the difference between the torques exerted on the two winding drums, since in the case of a thin information sheet the winding radius can be assumed to be roughly constant, and the tension can accordingly be calculated from the torque by means of a proportionality factor. Furthermore, in such cases a tension limit can be provided that switches off or throttles the driving electric motor if a value that endangers the information sheet is reached or exceeded.

Automatic positioning of predetermined information fields is possible if at least one drum shaft is provided with a position transducer. To this end, features distinguishing the individual information fields from one another can also be disposed on the sheet itself, for example markings printed in an otherwise transparent area in the region of a longitudinal margin and scanned by a light barrier disposed on the drum mounting or the drum housing; reflective areas that deflect a light beam to a sensor; metallic elements that can be scanned by means of inductive proximity switches, etc. Nevertheless, a very simple arrangement is also afforded by position transducers coupled to a drive motor, since, particularly in the case of information sheets affixed by their end sides to the winding drums, the total number of motor rotations is proportional to the unwound length of sheet and therefore permits unambiguous assignment to the individual information fields. In such cases a way is provided of stopping the sheet conveying apparatus at a given position in which the desired information field is visible exactly between the two winding drums, without visual monitoring by the truck driver.

To supply the drive and/or control units contained in the housing, a flexible cable can be provided, which is preferably led out of the housing through a sealed and for example grommet-equipped opening. The end of the cable can be provided with a plug connection element of the kind used to transmit the intrinsic on-board electrical voltage (usually 24 V) to a trailer, so installing the electrical system is limited in the ideal case to fitting this plug connection element together with the thereto-compatible, particularly approximately complementary, plug device of the truck.

Particularly in the case of a housing form improved to serve as a door, in running a power supply cable it is necessary to make allowance for the freedom of movement of the door. For this case, the invention provides that the power supply cable exits the housing on the top side of the housing or preferably on its bottom side, preferably in the vicinity of an edge thereof which is connected fixedly or via pivoting hinges to the cargo space sidewall.

The control device preferably has the use of an interface to a manual input device. Although in many cases it may be desired for the winding drums to execute a slow, steady conveying movement, in order for example to scroll extensive information past successively in a legibly slow manner, in the majority of cases manually settable, field-by-field adjustment of the information sheet is desired.

To transmit commands to the control device, the latter is preferably supplemented by a remote control, particularly a radio-operated remote. This has the considerable advantage that only one remote is needed in order to input control commands both from the cab—for example while driving—and from the back of the vehicle—for example when replacing the information sheet. A radio interface further has the advantage that no wiring of any kind need be done on the vehicle, and the inventive apparatus can therefore be installed and put into operation with only a few mechanical manipulations.

One important functionality of the input device is that it can be used to select one of a plurality of information fields provided on the information sheet. Like the images on the film from a 35 mm camera, the individual information fields on the information sheet can be provided with individual numbers, and when a given number is input the control device of the inventive information apparatus can recognize which information field is to be selected and positioned, and is then capable of automatically carrying out the necessary operations to execute this command. The radio interface can in this case be confined to the transmission of numerals or other ASCII characters, a particularly suitable option for this purpose being a digital modulation process, for example pulse modulation.

Further features, details, advantages and effects on the basis of the invention will emerge from the following description of preferred exemplary embodiments of the invention and by reference to the drawing. Therein:

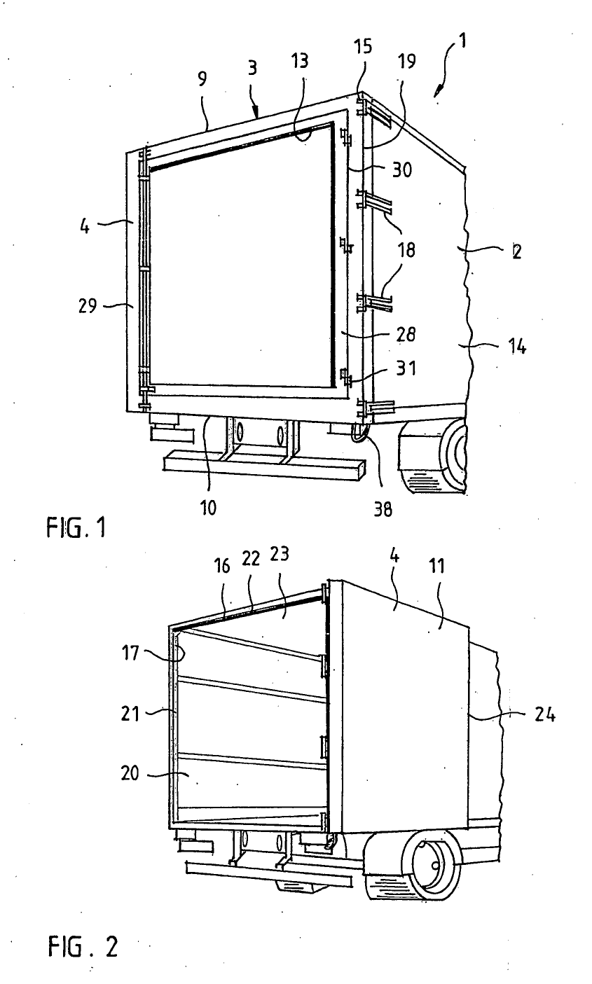

FIG. 1 shows the rear of a truck equipped with an information device [sic] according to the invention, implemented as a cargo space door, in the closed state;

FIG. 2 shows the information apparatus from FIG. 1 in a representation corresponding to that figure, but with the cargo space door completely open;

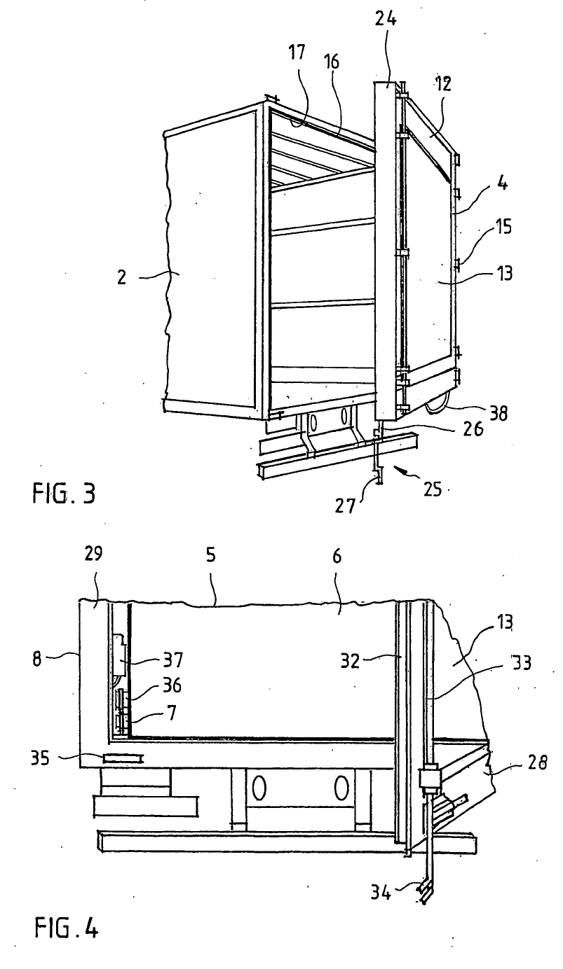

FIG. 3 shows the information apparatus from FIG. 1 in another perspective with the cargo space door partially open; and

FIG. 4 shows the information apparatus from FIG. 1 with the viewing window open.

The cargo space of the truck 1 depicted in the drawing is surrounded by a rigid sidewall 2. Loading is done through a door 4 disposed at the rear 3 and extending over the entire cross-sectional area of the cargo space.

The door 4 contains an inventive information apparatus 5 comprising an elongated information sheet 6, each of whose narrow sides is attached to a respective winding drum 7. The winding drums 7 extend parallel to the plane of the door. They are rotationally mounted in a horizontal orientation on mountings fixed in the housing 8 of the door 4, one along the top edge 9 and one along the bottom edge 10 of the door. The information sheet 6 is held taut between these two winding drums 7.

The housing 8 of the door 4 completely surrounds both winding drums 7 and the information sheet 6 disposed between them. The door 4 accordingly has a thickness that is greater than the diameter of a winding drum 7, for example about 10 cm.

The housing 8 forming the door 4 is completely closed on the inward side 11 facing the cargo space and also at all four corners. On the outward side 12, however, there is a viewing window 13, through which the information sheet 6 can be seen. The viewing window 13 can for example be made of Plexiglas.

As illustrated in FIG. 2, the door 4 can be swung open approximately 270°, such that in its open position it rests against the outward side 14 of the cargo space sidewall 2. This has the advantage that the viewing window 13 is covered and cannot be damaged by a clumsy movement.

This broad swing is made possible by the fact that the door hinges 15 are not located directly on the portal 16 of the cargo space opening 17, but on cantilevers 18 that are fixedly mounted thereon and project rearwardly by approximately the thickness of the door 4. In this way, the pivot axis for the door 4 is located at its rearward outer edge 19, and when the door 4 is completely open, its rear or outward side 12 can therefore come to lie in a planarly parallel manner against the outward side 14 of the cargo space sidewall 2.

Various measures are taken to enable the cantilevers 18 and in particular the sidewall 2 to support the door 4. For one thing, the door 4 is provided to be as light as possible. This is achieved by having the housing 8 preferably be made entirely of aluminum. For another thing, the portal 16 of the cargo space opening 17 is stiffened with metal struts 21, 22 on the inward side 20 of the sidewall 2. Two such struts 21 extend in the vertical direction along the two lateral sidewalls 2; they are connected to each other by another strut 22 in the region of the roof 23.

Disposed at the vertical edge 24 of the door 4 opposite from the door hinges 15 is a closing mechanism 25. This comprises a vertical rod 26 mounted in the region of the inward side 11 of the door 4 and comprising an actuating lever 27 at its bottom end. Attached to this rod 26 in the region of each of the top and bottom edges 9, 10 of the door is a respective hook, which in a given rotational and/or translational position of the rod 26 can be brought into engagement with thereto-complementary elements on the cargo space covering 2, in order to lock the door 4 in the closed state. Additional locking elements are disposed on the outward side 14 of the sidewall 2, at the location reached by the door's free edge 24 when the door 4 is swung completely open. The door 4 can be suspended there either by means of the hooks on the ends of the rod 26 or by means of the actuating lever 27.

To enable the information sheet 6 to be changed, the viewing window 13 can be opened. The latter is received in a frame 28, preferably also made of aluminum. The frame 28 fits into a cutout 29, shaped for example in the manner of a window casing, in the outward side 12 of the door housing 8. A circumferential seal ensures that no moisture or particles can penetrate into the interior of the door along the gap between the window frame 28 and the window casing 29. The window frame 28 is pivotably connected via hinges 31 to the window casing 29 at a vertical edge 30, preferably on the side where the door hinges 15 are located. Extending along the opposite, vertical window edge 32, as a closing mechanism, is a rod 33 mounted on and/or passed along the window frame 28 and comprising a hook 34 at each of its top and bottom ends. In a given rotational and/or translational position, these hooks 34 can be brought into engagement with hook receiving elements 35 on the window casing 29 to lock the viewing window 13 in the closed position.

As can further be appreciated from FIG. 4, the winding drums 7 are each coupled to a respective drive motor 36 and can therefore be driven and/or braked or stopped independently of each other. The drive motors 36 are secured in the housing 8, each in the immediate vicinity of its respective winding drum 7.

Both drive motors 36 are power-transmittingly connected to a common control device 37, which is also received in the housing 8. The control may also receive signals from position transducers and/or tachogenerators disposed on the motors 36 in order to draw conclusions therefrom regarding the tension status of the sheet 6, or it determines the tension status from the current consumption of the two motors 36 and their rotation speed.

The control 37 receives its commands by radio from a remote which the driver takes with him into the cab and can operate from that location. This reduces the necessary external wiring expenditure to the feed for the electric power needed by the drive motors 36 and the electronics 37. For this purpose, a power supply cable 38 is passed out of the door housing 8, specifically at the door's bottom edge 10, in the region of the door's vertical outward edge 19 provided with the door hinges 15. The power supply cable 38 is provided at its free end with a plug-type connector, which is preferably compatible with the plug-type connector of the truck 1 for supplying power to a trailer.

1. An information apparatus (5) attachable to a truck, and comprising an elongated, flexible, information-bearing sheet (6) which by each of two narrow ends is looped around a respective one of two spaced-apart, generally parallel, rotationally mounted winding drums (7) and can be wound therearound in plural layers, said winding drums (7) being arranged such that regions of said information sheet (6) are visible therebetween, each of said drums being coupled to a respective drive motor (36) to effect their rotational adjustment, such that different regions of said information sheet (6) become visible; wherein said information-bearing sheet (6) and the respective winding drums (7) are collectively disposed in a closed housing (8) of flat shape, comprising on a flat outward side (12) thereof a viewing window (13), and in a region of a rear side (11) thereof and at least one of end faces (9, 10, 19, 24) thereof, means (15, 25) for affixing the housing to an outward surface (14) of a selected one of cargo space (2) and a cargo area covering (23).

2. The information apparatus as in claim 1, wherein said housing (8) is made of a material that has a density of less than 3 kg/dm³.

3. The information apparatus as in claim 1, wherein said housing (8) is made of aluminum.

4. The information apparatus as in claim 1, wherein said information apparatus (5) comprises a door (4) of the cargo space of said truck (1).

5. The information apparatus as in claim 4, wherein said door (4) extends across an entire back wall (3) of said cargo space of said vehicle (1).

6. The information apparatus as in claim 4, wherein said door (4) is suspended (15, 18) such that in an open state said door can be swung over to an adjacent wall region (14) of said cargo space covering.

7. The information apparatus as in claim 6, wherein door hinges (15) are disposed in a region of an outward edge (19) of a door end face.

8. The information apparatus in accordance with claim 6, wherein counterparts of a closing mechanism (25) of said door (4) are disposed on a portal (16) of a cargo space opening (17) and in a region of a cargo space sidewall (2) to which a door lock (25) swivels when said door (4) is opened completely.

9. The information apparatus in accordance with claim 1, wherein said viewing window (13) is configured so that it can be swung out relative to said housing (8).

10. The information apparatus as in claim 9, wherein a frame (28) of said window (13) is disposed concentrically within a region of said housing (8) forming a casing (29).

11. The information apparatus in accordance with claim 1, wherein one of said two winding drums (7) is disposed in a region of a top edge (9) of said housing (8) and the other of said drums is disposed in a region of a bottom edge (10) of said housing.

12. The information apparatus in accordance with claim 1, wherein said housing (8) is supplied with power via a flexible cable (38).

13. The information apparatus as in claim 12, wherein the power supply cable (38) exits said housing (8) on a selected one of the top side (9) of said housing (8) and the bottom side (10) thereof, in a vicinity of an edge (19) connected to said cargo space sidewall (2).

14. The information apparatus in accordance with claim 1, wherein a control device (37) is coupled to said drive motors (36) and integrated into said housing (8).

15. The information apparatus as in claim 14, wherein said control device (37) is implemented such as to impart defined and coordinated rotational movements to said winding drums (7) coupled to said drive motors (37), such that said information sheet (6) is held stretched taut between said winding drums (7).

16. The information apparatus as in claim 14, wherein said control device (37) is implemented such that said drive motors (36) of said winding drums (7) are operable as braking devices.

17. The information apparatus in accordance with claim 16, further comprising a radio-operated remote control, for transmitting commands to said control device (37).

18. The information apparatus in accordance with claim 1, wherein said information sheet (6) comprises at narrow sides thereof means for effecting attachment to said winding drums (7), comprising a selected one of snap-type fasteners, hook elements, and adhesive strips, counterparts thereof being disposed on outward jacket surfaces of said winding drums (7).
